(19) United States
(12) Patent Application Publication
(10) Pub. No.: US 2007/0041292 A1
(43) Pub. Date: Feb. 22, 2007

(54) Disk reproducing apparatus

(75) Inventor: Yasumasa Igi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/505,429

(22) Filed: Aug. 17, 2006

(30) Foreign Application Priority Data
Aug. 22, 2005 (JP) P2005-239780

(51) Int. Cl. G11B 19/00

(52) U.S. Cl. 369/47.39

(57) ABSTRACT

A disk reproducing apparatus that includes: a first rotation control unit that applies a constant drive voltage to a spindle motor to thereby rotate an optical disk; a measuring unit that measures the length of the longest bit included in an EFM signal on information data reproduced from the optical disk based on a reference clock; a calculating unit that calculates the number of rotations of the optical disk from the longest bit length measured by the measuring means; and a setting unit that, based on a mutual relationship between the drive voltage of the spindle motor and the number of rotations of the optical disk, sets a gain of a motor drive IC according to the number of rotations of the optical disk calculated by the calculating unit.

### BACKGROUND OF THE INVENTION

1. Field of the Invention

The present invention relates to a disk reproducing apparatus for reproducing information data recorded in an optical disk and, more specifically, the invention relates to a disk reproducing apparatus which can control variations in the start characteristics of the rotation of a spindle motor for rotating the optical disk as well as variations in the number of rotations of the spindle motor.

2. Description of the Related Art

Generally, with regard to spindle motors used to rotate an optical disk, the spindle motors vary in the rotation characteristics thereof from motor to motor, the motor drivers thereof vary in the output characteristics thereof from driver to driver, and optical disks vary in mass from disk to disk; and thus, the time necessary for the optical disk to reach a given number of rotations varies from one spindle motor to another, or, when a given drive voltage is applied to the spindle motors, the number of rotations of the spindle motors varies from one spindle motor to another. Therefore, to control the number of rotations of the spindle motor, the number of rotations of the spindle motor is detected according to an FG (Frequency Generator) signal generated due to the rotational movement of the spindle motor to thereby control the number of rotations of the spindle motor. However, in this case, to control the number of rotations of the spindle motor according to the FG signal, it is necessary to use an FG device which generates the FG signal. This raises a problem that the production cost of a disk reproducing apparatus cannot be reduced.

As the background art, there is known a disk reproducing apparatus in which, when the length of the longest bit of an optical disk is within the range of a reference time, a spindle motor is servo controlled by a control output generated according to a synchronizing signal detected from the optical disk; and, when the length of the longest bit of the optical disk is outside the range of the reference time, the spindle motor is servo controlled by a control output generated according to the detection of the length of the longest bit of the optical disk (for example, see JP-A-63-178783).

Conventionally, there is also known a disk reproducing apparatus in which the bit length of a frame sink included in a signal read out from an optical disk is counted, there is obtained a difference between the count value of the frame sink and a reference count value of a frame sink at a regular linear velocity, and a pulse signal having a pulse length proportional to the thus obtained difference is converted to a speed error signal in which a voltage smoothly changes according to a deviation from the regular linear velocity, thereby controlling the rotation of the spindle motor (for example, see JP-A-6-52629).

Also, conventionally, there is known a disk reproducing apparatus in which the reproducing signals of a disk are binarized using a clock having a constant frequency, the binarized reproducing signals are sampled, a sample mark length in which the same sample values of the sampled values are continuous is measured, and the linear velocity of the disk is calculated according to the measured sample mark length and a mark length recorded on the disk, thereby controlling the rotation of a spindle motor (for example, see JP-A-2000-164735).

### SUMMARY OF THE INVENTION

However, there have been found problems in the conventional disk reproducing apparatuses cited above. Specifically, in the first conventional disk reproducing apparatus, when the length of the longest bit of the optical disk is within the range of the reference time, the spindle motor can be servo controlled using the control output generated according to the synchronizing signal detected from the optical disk and, when the length of the longest bit of the optical disk is outside the range of the reference time, the spindle motor can be servo controlled using the control output generated according to the detection of the length of the longest bit of the optical disk. In other words, this is a disk reproducing apparatus which, when starting the reproduction of the optical disk, servo controls the rotation of the spindle motor using the control output generated according to the detection of the length of the longest bit. Thus, the object of this conventional technique is not to provide a disk reproducing apparatus which, when starting the rotation of a spindle motor, starts the rotation of the spindle motor at a high speed to thereby shorten the time for start of the rotation of the spindle motor.

Also, in the second conventional disk reproducing apparatus, the bit length of the frame sink included in the signal read out from the optical disk is counted, a difference between the count value of the frame sink and the reference count value of the frame sink at a regular linear velocity is obtained, and a pulse signal having a pulse length proportional to the thus obtained difference is converted to a speed error signal the voltage of which varies smoothly according to the deviation thereof from the regular linear velocity to thereby be able to control the rotation of the spindle motor. That is, according to the second conventional technique, there is provided a disk reproducing apparatus which rough servo controls the rotation of the spindle motor using the speed error signal the voltage of which varies smoothly according to the deviation thereof from the regular linear speed. Thus, similarly to the first conventional technique, the second technique does not aim at providing a disk reproducing apparatus which, when starting the rotation of the spindle motor, can start the rotation of the spindle motor at a high speed to thereby be able to shorten the time for start of the rotation of the spindle motor.

Further, in the third conventional technique, the reproducing signals of a disk are binarized using a clock having a constant frequency, the binarized reproducing signals are sampled, a sample mark length in which the same sample values of the sampled values are continuous is measured, and the linear velocity of the disk is calculated according to the measured sample mark and a mark length recorded on the disk, thereby being able to control the rotation of a spindle motor. In other words, the aim of this technique is that the rotation control system of the spindle motor is made difficult to be influenced by a burst error or a random error. That is, this technique does not aim at solving the above-mentioned problems.

The present invention is made in order to solve the problems found in the background art and thus the object of the invention is to provide a disk reproducing apparatus which, without using an FG signal for detecting the rotation of a spindle motor for rotating an optical disk, not only can prevent spindle motors from varying in the number of rotations from motor to motor when a given drive voltage is applied to them but also can shorten the time for start of the rotation of the spindle motors.

According to the invention, there is provided a disk reproducing apparatus for reproducing information data recorded in an optical disk, comprising: first rotation control means for applying a constant drive voltage to a spindle motor to thereby rotate the optical disk; measuring means for measuring the length of the longest bit included in an EFM signal on information data reproduced from the optical disk according to a reference clock; calculating means for calculating the number of rotations of the optical disk from the longest bit length measured by the measuring means; and setting means, based on the mutual relationship between the drive voltage of the spindle motor and the number of rotations of the optical disk, for setting the gain of a motor drive IC according to the number of rotations of the optical disk calculated by the calculating means.

The present disk reproducing apparatus may further include: second rotation control means which, when the reproduction of the optical disk is started, applies the maximum drive voltage to the spindle motor to thereby rotate the spindle motor; and, drive voltage change means which, when the number of rotations of the optical disk calculated by the calculating means reaches substantially a given number of rotations, lowers the drive voltage of the spindle motor down to a given voltage.

Also, the present disk reproducing apparatus may further include adjust means which, after the drive voltage of the spindle motor is lowered down to a given voltage by the drive voltage change means, when the number of rotations of the optical disk does not reach a given number of rotations, adjusts the drive voltage of the spindle motor according to the number of rotations of the optical disk calculated by the calculating means.

According to these means, the present disk reproducing apparatus, without using an FG signal for detecting the rotation of a spindle motor for rotating an optical disk, not only can prevent spindle motors from varying in the number of rotations thereof from one spindle motor to another when a given drive voltage is applied to them but also can shorten the time for start of the rotation of the spindle motors.

According to a disk reproducing apparatus of the invention, a constant drive voltage is applied to a spindle motor to thereby rotate the optical disk, the length of the longest bit included in an EFM signal on information data reproduced from the optical disk is measured according to a reference clock, the number of rotations of the optical disk is calculated from the measured longest bit length, and, based on the mutual relationship between the drive voltage of the spindle motor and the number of rotations of the optical disk, the gain of a motor drive IC is set according to the calculated number of rotations of the optical disk. Thanks to this, the present disk reproducing apparatus, without using the FG signal which is used to detect the rotation of the spindle motor for rotating the optical disk, can improve variations in the start characteristics of the spindle motor caused by the variations of the characteristics of the spindle motor and the motor drive IC of a spindle servo circuit as well as by the variations of the mass of the optical disk, thereby being able to prevent spindle motors from varying in the number of rotations thereof from spindle motor one to another when a given drive voltage is applied to them. Also, in the time to start the reproduction of the optical disk, the maximum drive voltage is applied to the spindle motor to rotate it; when the calculated number of rotations of the optical disk reaches substantially a given number of rotations, the drive voltage of the spindle motor is lowered down to a given voltage; and, after the drive voltage of the spindle motor is lowered down to the given voltage, unless the number of rotations of the optical disk reaches the given number of rotations, the drive voltage of the spindle motor is adjusted according to the calculated number of rotations of the optical disk. Therefore, the time for start of rotation of the spindle motor can be reduced and also, unless the number of rotations of the optical disk reaches the given number of rotations when the given drive voltage is applied to the spindle motor, the drive voltage of the spindle motor can be adjusted to thereby be able to rotate the spindle motor at a given number of rotations.

According to a disk reproducing apparatus of the invention, a constant drive voltage is applied to a spindle motor to thereby rotate the optical disk, the length of the longest bit included in an EFM signal on information data reproduced from the optical disk is measured according to a reference clock, the number of rotations of the optical disk is calculated from the measured longest bit length, and, based on the mutual relationship between the drive voltage of the spindle motor and the number of rotations of the optical disk, the gain of a motor drive IC is set according to the calculated number of rotations of the optical disk. Thanks to this, the present disk reproducing apparatus, without using the FG signal which is used to detect the rotation of the spindle motor for rotating the optical disk, can improve variations in the start characteristics of the spindle motor caused by the variations of the characteristics of the spindle motor and the motor drive IC of a spindle servo circuit as well as by the variations of the mass of the optical disk, thereby being able to prevent spindle motors from varying in the number of rotations thereof from one spindle motor to another when a given drive voltage is applied to them.

Also, according to a disk reproducing apparatus of the invention, in the time to start the reproduction of the optical disk, the maximum drive voltage is applied to the spindle motor to rotate it and, when the calculated number of rotations of the optical disk reaches substantially a given number of rotations, the drive voltage of the spindle motor is lowered down to a given voltage. This makes it possible to reduce the time for start of rotation of the spindle motor.

Further, according to a disk reproducing apparatus of the invention, after the drive voltage of the spindle motor is lowered down to a given voltage, unless the number of rotations of the optical disk reaches a given number of rotations, the drive voltage of the spindle motor is adjusted according to the calculated number of rotations of the optical disk. Therefore, unless the number of rotations of the optical disk reaches the given number of rotations when the given drive voltage is applied to the spindle motor, the drive voltage of the spindle motor can be adjusted to thereby be able to rotate the spindle motor at a given number of rotations.

### BRIEF DESCRIPTION OF THE DRAWINGS

FIG. 1 is a block diagram of the structure of a disk reproducing apparatus according to an embodiment of the invention;

FIG. 2 is a view of a longest bit signal included in an EFM signal of a reproducing signal;

FIGS. 3A and 3B are explanatory views of the operation of a disk reproducing apparatus according to the embodiment of the invention;

FIG. 4 is a flow chart of the operation of a disk reproducing apparatus according to the embodiment of the invention; and

FIG. 5 is a flowchart of the operation of a disk reproducing apparatus according to the embodiment of the invention.

### DETAILED DESCRIPTION OF THE PREFERRED EMBODIMENTS

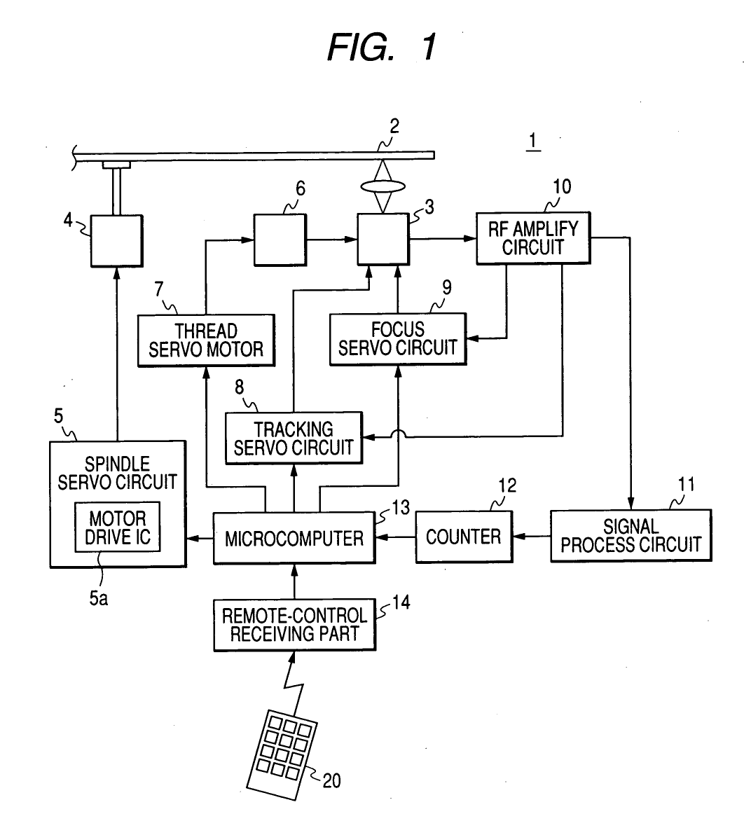

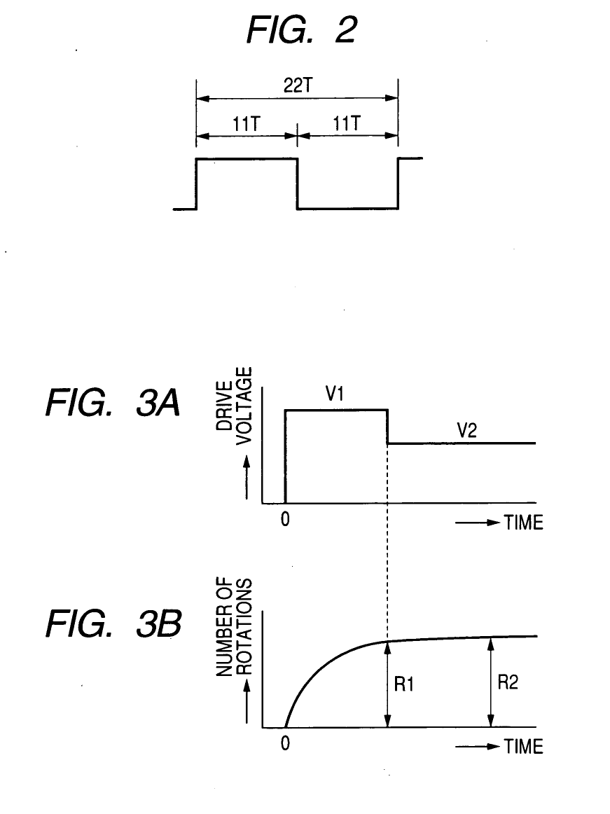

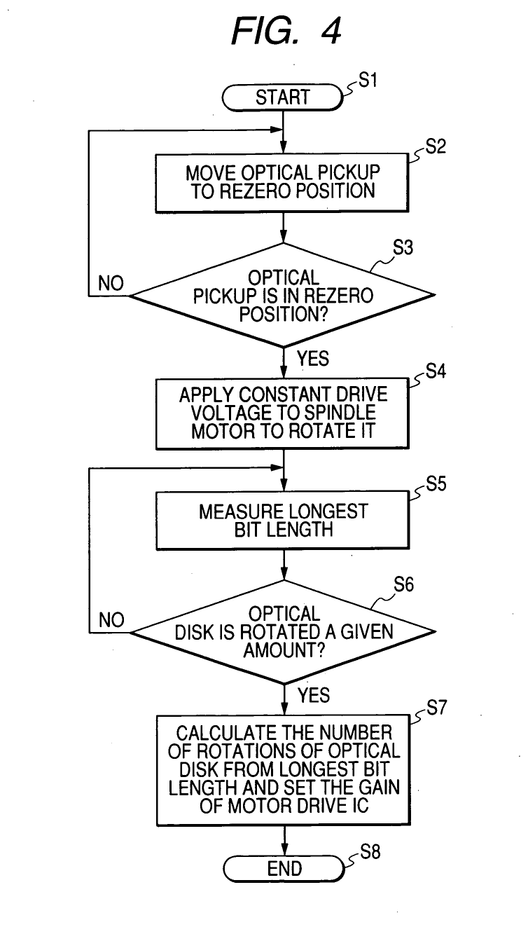

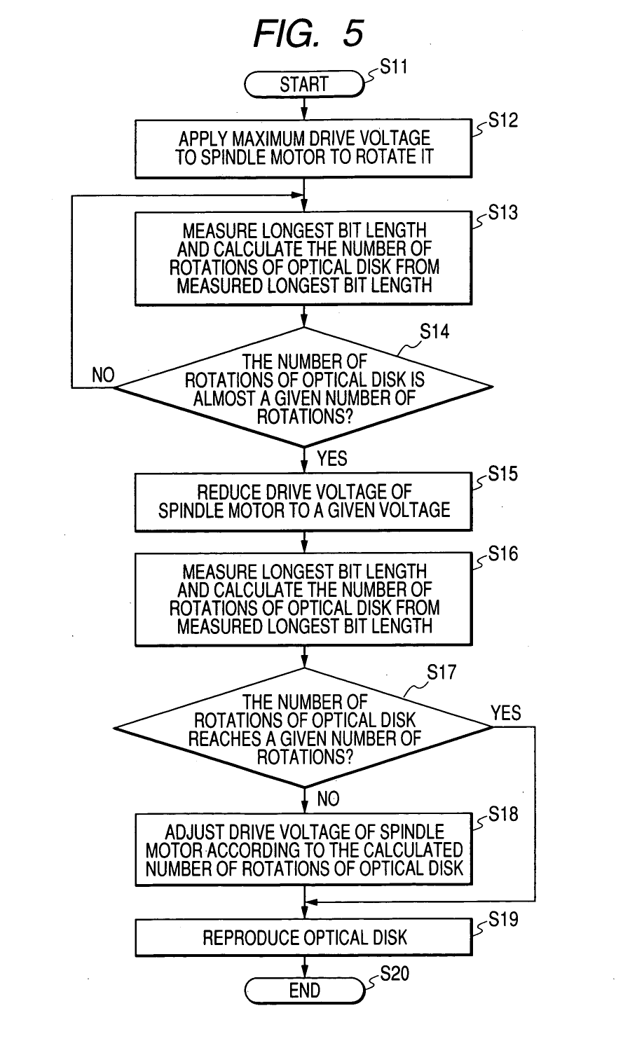

Now, description will be given below in detail of an embodiment of the invention while referring to the accompanying drawings. Specifically, FIG. 1 is a block diagram of the structure of a disk reproducing apparatus according to an embodiment of the invention. FIG. 2 is a view of the longest bit signal included in an EFM signal of a reproducing signal. FIGS. 3A and 3B are explanatory views of the operation of a disk reproducing apparatus according to the embodiment of the invention. FIG. 4 is a flow chart of the operation of a disk reproducing apparatus according to the embodiment of the invention. FIG. 5 is a flow chart of the operation of a disk reproducing apparatus according to the embodiment of the invention.

Firstly, description will be given below of the embodiment of the invention with reference to FIG. 1 which is a block diagram of the structure of a disk reproducing apparatus according to the embodiment of the invention.

A disk reproducing apparatus 1 comprises: an optical pickup 3 which radiates a laser beam onto an optical disk 2 to detect the reflected light thereof and reads out information data recorded in the optical disk 2; a spindle motor 4 for rotating the optical disk 2; a spindle servo circuit 5 which drives the spindle motor 4 using its motor drive IC 5a to thereby servo control the rotation speed of the optical disk 2; a thread motor 6 for thread moving the optical pickup 3 in the radial direction of the optical disk 2; a thread servo circuit 7 for servo controlling the rotation direction and rotation speed of the thread motor 6; a tracking servo circuit 8 for servo controlling the tracking of the optical pickup 3 according to a tracking error signal detected by the optical pickup 3; a focus servo circuit 9 for servo controlling the focus of the optical pickup 3 according to a focus error signal detected by the optical pickup 3; an RF amplify circuit 10 for amplifying an RF (Radio Frequency) signal read out by the optical pickup 3; a signal process circuit 11 which synchronously detects the RF signal on the information data amplified by the RF amplify circuit 10 according to a reference clock and demodulates the information data, corrects errors in the demodulated information data, expands information data compressed according to a given compression system to thereby demodulate it, and reproduces the information data recorded in the optical disk 2; a counter 12 for measuring the longest bit length 11T (T: the cycle of a recording bit. See FIG. 2) included in an EFM (Eight to Fourteen Modulation) signal on the information data reproduced by the signal process circuit 11 according to the reference clock; a microcomputer 13 for controlling the whole system of the disk reproducing apparatus 1; and, a remote-control receiving part 14 which receives a remote control signal of an infrared signal transmitted from a remote-control device 20 and converts the remote control signal to a given electric signal.

Now, description will be given below of the operation of the above-structured disk reproducing apparatus.

When the optical disk 2 is loaded into the disk reproducing apparatus 1, the microcomputer 13 issues a control signal to the thread servo circuit 7 so that the thread motor 6 is rotated to thereby move the optical pickup 3 to the rezero position of the optical disk 2. When the optical pickup 3 is moved to the rezero position, the microcomputer 13 issues a control signal to the spindle servo circuit 5 to apply a constant drive voltage to the spindle motor 4, thereby rotating the spindle motor 4; and also, the microcomputer 13 issues a control signal to the focus servo circuit 9 to turn on the focus servo of the optical pickup 3, so that the information data recorded in the optical disk 2 is read out by the optical pickup 3, the information data is reproduced by the signal process circuit 11, and the longest bit length 11T (see FIG. 2) included in the EFM signal on the reproduced information data is measured according to a reference clock by the counter 12.

And, it is checked whether the optical disk 2 is rotated a given amount, for example, once or not. When it is found that the optical disk 2 is rotated a given amount, the microcomputer 13 calculates the number of rotations of the optical disk 2 from the longest bit length 11T measured by the counter 12 and, based on the mutual relationship between the drive voltage of the spindle motor 4 and the number rotations of the optical disk 2, sets the gain of the motor drive IC 5a of the spindle servo circuit 5 according to the calculated number of rotations of the optical disk 2. This not only can improve variations in the start characteristics of the spindle motor caused by the variations of the characteristics of the motor drive IC of the spindle servo circuit and by the variations of the mass of the optical disk, but also can prevent the spindle motors from varying in the number of rotations thereof from one spindle motor to another when a given drive voltage is applied to them.

Also when, the reproduction of the optical disk 2 is instructed by the key operation of the remote-control device 20, the microcomputer 13 issues a control signal to the spindle servo circuit 5 to apply a maximum drive voltage V1 to the spindle motor 4 to thereby rotate the spindle motor 4 (see FIG. 3A). At the same time, the microcomputer 13 issues a control signal to the tracking servo circuit 8 and focus servo circuit 9 respectively to turn on the tracking servo and focus servo of the optical pickup 3 respectively, whereby the information data recorded in the optical disk 2 is read out by the optical pickup 3, the information data is reproduced by the signal process circuit 11, the longest bit length 11T in the EFM signal on the reproduced information data is measured by the counter 12 according to a reference clock, and the number of rotations of the optical disk 2 is calculated from the longest bit length 11T measured by the counter 12; and, when the number of rotations of the optical disk 2 substantially reaches a given number of rotations R1, for example, when it reaches a number of rotations which is 90% to 95% of a given number of rotations R2 (see FIG. 3B), the microcomputer 13 issues a control signal to the spindle servo circuit 5 to thereby lower the drive voltage of the spindle motor 4 down to a given voltage V2 which allows the optical disk 2 to rotate at the given number of rotations R1 (see FIG. 3A).

After the drive voltage of the spindle motor 4 is lowered down to the given voltage V2, unless the number of rotations of the optical disk 2 provides the given number of rotations R2, the microcomputer 13 issues a control signal to the spindle servo circuit 5 to thereby adjust the drive voltage of the spindle motor according to the number of rotations of the optical disk 2 calculated from the longest bit length 11T measured by the counter 12. And, when the number of rotations of the optical disk 2 provides the given number of rotations R2, the microcomputer 13 drives the optical pickup 3 to read out the information data recorded in the optical disk 2 so as to reproduce the information data recorded in the optical disk 2. Thus, when reproducing the optical disk, the maximum drive voltage is applied to the spindle motor to thereby start the rotation of the spindle motor at a high speed, so that the time for start of the rotation of the spindle motor can be shortened.

Next, description will be given below of the operation of a disk reproducing apparatus according to the embodiment of the invention with reference to FIG. 4 which is a flow chart of the same operation.

When an optical disk is loaded into the disk reproducing apparatus, the processing goes from Step S1 to Step S2. In Step S2, the optical pickup is moved to the rezero position of the optical disk and then the processing advances to Step S3.

In Step S3, it is checked whether the optical pickup is moved to the rezero position or not. When it is found that the optical pickup is moved to the rezero position, the processing advances to Step S4; and, when it is found that the optical pickup is not moved to the rezero position, the processing goes back to Step S2 and the processings in Steps S2 and S3 are repeated. In Step S4, a constant drive voltage is applied to the spindle motor to thereby rotate the spindle motor and, after then, the processing advances to Step S5.

In Step S5, the focus servo is turned on and the longest bit length in the EFM signal on the information data reproduced from the optical disk is measured according to a reference clock and, after then, the processing advances to Step S6.

In Step S6, it is checked whether the optical disk is rotated a given amount or not. When it is found that the optical disk is rotated a given amount, the processing advances to Step S7. When it is found that the optical disk is not rotated a given amount, the processing goes back to Step S5 and the processings in Steps S5 and S6 are repeated.

In Step S7, the number of rotations of the optical disk is calculated from the longest bit length measured and, based on the mutual relationship between the drive voltage of the spindle motor and the number of rotations of the optical disk, the gain of the motor drive IC of the spindle servo circuit is set according to the calculated number of rotations the optical disk. After then, the processing advances to Step S8, where the processing is ended.

Further, description will be given below of the operation of a disk reproducing apparatus according to the embodiment of the invention with reference to FIG. 5 which is a flow chart of the same operation.

When the reproduction of the optical disk is instructed by the key operation of the remote-control device, the processing goes from Step S11 to Step S12. In Step S12, a maximum drive voltage is applied to the spindle motor to thereby rotate the spindle motor. After then, the processing advances to Step S13.

In Step 13, the longest bit length in the EFM signal on the information data reproduced from the optical disk is measured according to a reference clock and the number of rotations of the optical disk is calculated from the measured longest bit length. After then, the processing advances to Step S14.

In Step S14, it is checked whether the number of rotations of the optical disk reaches substantially a given number of rotations or not. When it is found that the number of rotations of the optical disk reaches substantially a given number of rotations, the processing advances to Step S15. When it is found that the number of rotations of the optical disk does not reach substantially a given number of rotations, the processing goes back to Step S13 and the processings in Steps S13 and 14 are repeated.

In Step S15, the drive voltage of the spindle motor is reduced down to a given voltage which allows the optical disk to rotate at a given number of rotations. After then, the processing advances to Step S16.

In Step S16, the length of the longest bit included in the EFM signal on the information data reproduced from the optical disk is measured according to a reference clock and the number of rotations of the optical disk is calculated from the measured longest bit length. After then, the processing advances to Step S17.

In Step S17, it is checked whether the number of rotations of the optical disk reaches a given number of rotations or not. When it is found that the number of rotations of the optical disk reaches a given number of rotations, the processing advances to Step S19. When it is found that the number of rotations of the optical disk does not reach a given number of rotations, the processing advances to Step S18.

In Step S18, the drive voltage of the spindle motor is adjusted according to the number of rotations of the optical disk calculated from the longest bit length. After then, the processing goes to Step S19.

In Step S19, the information data recorded in the optical disk is read out by the optical pickup and thus the information data recorded in the optical disk is reproduced. After then, the processing advances to Step S20, where the processing is ended.

Although description has been given heretofore in detail of the embodiment the invention, the invention is not limited to this but it goes without saying that other various changes and modifications are also possible within the normal knowledge of persons who are skilled in the art. For example, in the present specification, description has been given of the embodiment in which the longest bit signal included in the EFM signal is measured and the number of rotations of the optical disk is calculated from the measured EFM signal to thereby control the rotation of the spindle motor. However, alternatively, there may also be employed an embodiment in which a wobble signal and a land pre-pit signal previously recorded in the optical disk are measured and the number of rotations of the optical disk is calculated from the measured signals to thereby control the rotation of the spindle motor.

What is claimed is:

1. A disk reproducing apparatus for reproducing information data recorded in an optical disk, comprising:
first rotation control means for applying a constant drive voltage to a spindle motor to thereby rotate the optical disk;
measuring means for measuring the length of the longest bit included in an EFM signal on information data reproduced from the optical disk based on a reference clock;
calculating means for calculating the number of rotations of the optical disk from the longest bit length measured by the measuring means;
setting means, based on a mutual relationship between the drive voltage of the spindle motor and the number of rotations of the optical disk, for setting a gain of a motor drive IC according to the number of rotations of the optical disk calculated by the calculating means;
second rotation control means, when the reproduction of the optical disk is started, for applying the maximum drive voltage to the spindle motor to thereby rotate the spindle motor;
drive voltage change means, when the number of rotations of the optical disk calculated by the calculating means reaches substantially a given number of rotations, for lowering the drive voltage of the spindle motor down to a given voltage; and
adjust means, after the drive voltage of the spindle motor is lowered down to a given voltage by the drive voltage change means, when the number of rotations of the optical disk does not reach a given number of rotations, for adjusting the drive voltage of the spindle motor according to the number of rotations of the optical disk calculated by the calculating means.

2. A disk reproducing apparatus for reproducing information data recorded in an optical disk, comprising:
first rotation control means for applying a constant drive voltage to a spindle motor to thereby rotate the optical disk;
measuring means for measuring the length of the longest bit included in an EFM signal on information data reproduced from the optical disk based on a reference clock;
calculating means for calculating the number of rotations of the optical disk from the longest bit length measured by the measuring means; and
setting means, based on a mutual relationship between the drive voltage of the spindle motor and the number of rotations of the optical disk, for setting a gain of a motor drive IC according to the number of rotations of the optical disk calculated by the calculating means.

3. The disk reproducing apparatus as set forth in claim 2, further comprising:
second rotation control means for applying the maximum drive voltage to the spindle motor to thereby rotate the spindle motor; and
drive voltage change means, when the number of rotations of the optical disk calculated by the calculating means reaches substantially a given number of rotations, for lowering the drive voltage of the spindle motor down to a given voltage.

4. The disk reproducing apparatus as set forth in claim 3, further comprising adjust means which, after the drive voltage of the spindle motor is lowered down to a given voltage by the drive voltage change means when the number of rotations of the optical disk does not reach a given number of rotations, adjusts the drive voltage of the spindle motor according to the number of rotations of the optical disk calculated by the calculating means.

5. A disk reproducing apparatus for reproducing information data recorded in an optical disk, comprising:
a first rotation control unit that applies a constant drive voltage to a spindle motor to thereby rotate the optical disk;
a measuring unit that measures the length of the longest bit included in an EFM signal on information data reproduced from the optical disk based on a reference clock;
a calculating unit that calculates the number of rotations of the optical disk from the longest bit length measured by the measuring means; and
a setting unit that, based on a mutual relationship between the drive voltage of the spindle motor and the number of rotations of the optical disk, sets a gain of a motor drive IC according to the number of rotations of the optical disk calculated by the calculating unit.
